(19) United States
(12) Patent Application Publication
(10) Pub. No.: US 2006/0220797 A1
(43) Pub. Date: Oct. 5, 2006

(54) Doorbell blocking device

(76) Inventors: Michael J. Valentino, Batavia, IL (US); Kerri Valentino, Batavia, IL (US)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/371,205

(22) Filed: Mar. 7, 2006

Related U.S. Application Data
(60) Provisional application No. 60/594,041, filed on Mar. 7, 2005.

(51) Int. Cl. G07C 11/00

(52) U.S. Cl. 340/286.06; 200/43.01; 340/384.7

(57) ABSTRACT

A device for blocking the ringing of a doorbell is disclosed. The device has a cover body with front, side, top and bottom sides. The front side also has a selectively closable opening, which has an outer perimeter. The front side also has at least one hole in it, which allows passage of a securing device, through the hole for securing the device. The selectively closeable opening has a plurality of panels slidably attached to the interior surface of the front side. The panels are slidably movable between an open position and a closed position. In the open position, the panels can stack, one in front of the other in a position that is substantially outside the outer perimeter of the selectively closable opening in the front side. The panels can have written indicia on them which is viewable when the panels are in the closed position.

### FIELD OF THE INVENTION

The present invention relates to doorbells, and more specifically to a device for blocking the ringing of a doorbell by preventing activation of the doorbell button.

### DESCRIPTION OF THE RELATED ART

Prior doorbell blocking devices are known to exist. For example, U.S. Pat. No. 2,447,226, issued to Bennett, discloses a sign for electric doorbell switches. This device has a swingably supported shield mounted on a bracket. The bracket is adapted to fasten to an existing appliance, such as a doorbell button structure. The shield can be swung up to expose the button or swung down to obstruct the button. The shield also has a legend or warning on each side, where one side is visible when the shield is swung up and the other side is visible when the shield is swung down. Drawbacks of this doorbell blocking device include the doorbell button needing to be removed for installation, the shield requires a portion of the doorbell button structure to act as a primary contact point to prevent activation of the doorbell button, the doorbell button is still exposed to the elements, and the shield may be blown into the down position be strong winds.

U.S. Pat. No. 5,077,452, issued to Mathers et al., discloses a doorbell block. The doorbell block has a cover and a pair of moveable sidewalls, which are biased towards each other to grippingly engage a doorbell housing. Tab openings allow the user to spread the sidewalls apart for installation and removal. A biasing spring urges the sidewalls together to grippingly engage the doorbell housing to retain the cover in place. Drawbacks of this doorbell blocking device include the required removal and storage of the cover in order to expose the doorbell button for normal use.

Therefore, there remains a need for a doorbell blocking device that is easily installable for a variety of doorbell buttons, protects the doorbell button from the elements, is easily operated, and easily switches from a blocking mode to a normal use mode without removal of the device. Thus, it would be advantageous to provide a doorbell blocking device that can be easily installed, can protect the doorbell button from the elements, can be easily operated, and can be easily switched from a blocking mode to a normal use mode without removal of the device.

### SUMMARY

In view of the deficiencies described above, it is an object of the present invention to provide a doorbell blocking device that can be easily installed, can protect the doorbell button from the elements, can be easily operated, and can be easily switched from a blocking mode to a normal use mode without removal of the device.

The present invention is a device for blocking the ringing of a doorbell. The device may be particularly useful when it is desirable to avoid noise, such as to avoid waking a sleeping baby. The device has a cover body with front, side, top and bottom sides. The front side has an interior surface and an exterior surface. The front side also has a selectively closable opening, which has an outer perimeter. The front side also has at least one hole in it, which allows passage of a securing device, through the hole for securing the device. The hole or holes can be configured to align with the attachment points for the doorbell that is to be blocked.

The selectively closeable opening has a plurality of panels slidably attached to the interior surface of the front side. The panels are slidably movable between an open position and a closed position. In the open position, the panels can stack, one in front of the other in a position that is substantially outside the outer perimeter of the selectively closable opening in the front side.

In other various preferred embodiments, the panels can have written indicia on them. The written indicia can include, but is not limited to, messages instructing a user not to ring the doorbell. The written indicia can be viewed the panels are in the closed position.

Other features and advantages of the invention will be apparent from the following detailed description taken in conjunction with the following figures, wherein like reference numerals represent like features.

### BRIEF DESCRIPTION OF THE FIGURES

FIG. 1 shows a front perspective of a doorbell blocking device according to the present invention.

FIG. 2 shows a rear perspective of a doorbell blocking device according to the present invention.

FIG. 3 shows a front perspective view of a doorbell blocking device according to the present invention with the panels in the closed position.

FIG. 4 shows a front perspective view of a doorbell blocking device according to the present invention with the panels in the open position.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

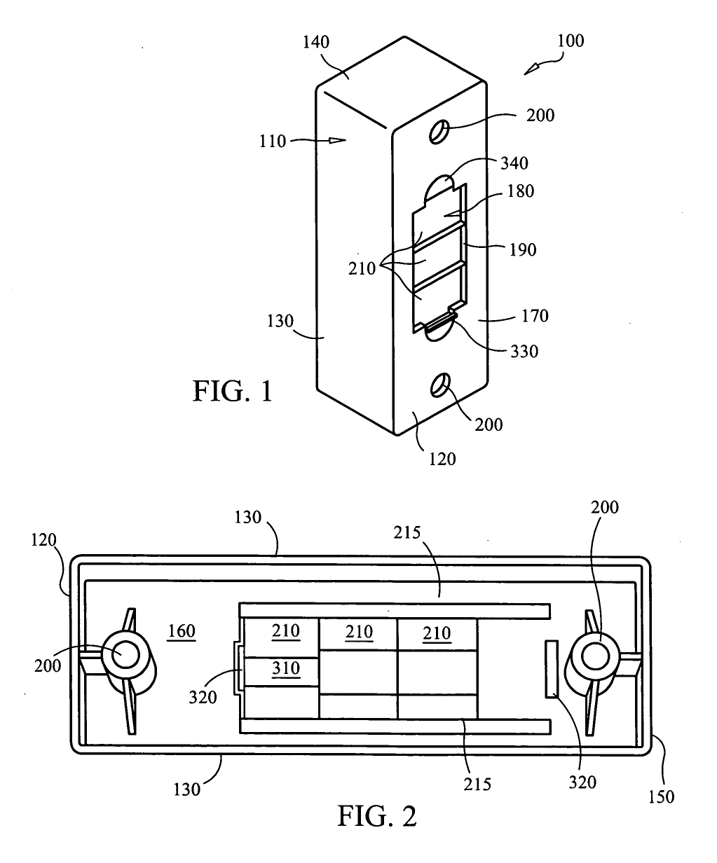

The present invention is a device for blocking the ringing of a doorbell. FIG. 1 shows a front perspective view of a doorbell blocking device according to the present invention. FIG. 2 shows a rear perspective view of a doorbell blocking device according to the present invention. The device 100 has a cover body 110 with front 120, side 130, top 140 and bottom 150 sides. The front side 120 has an interior surface 160 and an exterior surface 170. The front side 120 also has a selectively closable opening 180, which has an outer perimeter 190.

The front side 120 also has at least one hole 200 in it, which allows passage of a securing device (not shown), such as a screw, through the hole 200 for securing the device 100 to a desired object, such as a wall. In various embodiments, the hole or holes 200 can be configured to align with the attachment points (not shown) for the doorbell that is to be blocked. In these embodiments, the securing device or devices can replace the securing means for the doorbell. In various embodiments, the device 100 optionally includes multiple holes for alignment with different doorbell configurations. In yet other embodiments, the securing means may be located on other portions of the device 100 such as a flange (not shown) on the back side (not shown) of the device 100, or may comprise gripping means.

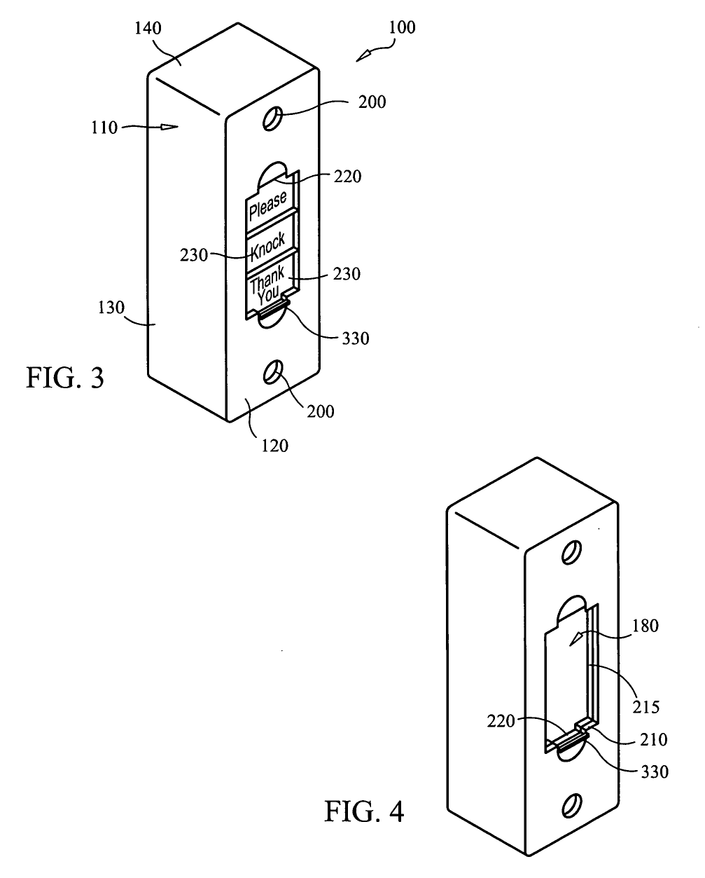

In various preferred embodiments, the selectively closeable opening 180 has a plurality of panels 210 slidably attached to the interior surface 160 of the front side 120. For example, rails 215 may be formed or installed on interior surface 160 to hold panels 210 and allow them to slide. The panels 210 are slidably movable between an open position and a closed position. A plate 310 and magnet 320 may be included to hold the panels in an open or closed position. A tab 330 may be included to allow a user to engage the panels in order to open or close. Also, indentations 340 may be present in order to allow the user easier access to the tab 330. In the open position, the doorbell button may be freely accessed. In the closed position, the doorbell button is blocked from being used. FIG. 3 shows a front perspective view of a doorbell blocking device 100 according to the present invention with the panels 210 in the closed position. Preferably, the panels 210 are operatively interconnected in a manner known in the art, which may include, but is not limited to overlapping tab portions (not shown), such that a user need only move one panel 210 to effectively move each of the panels 210. For example, the rearward most panel of the plurality of panels 210 can have a user graspable portion 220, such as a tab or the like, for sliding the panels 210. In the open position, the panels 210 can stack, one in front of the other in a position that is substantially outside the outer perimeter 190 of the selectively closable opening 180 in the front side 120. FIG. 4 shows a front perspective view of a doorbell blocking device 100 according to the present invention with the panels 210 in the open position.

In other various preferred embodiments, the panels 210 can have written indicia 230 on them. The written indicia 230 can include, but is not limited to, messages instructing a user not to ring the doorbell. The written indicia 230 is viewable when the panels are 210 are in the closed position.

While specific embodiments have been illustrated and described, numerous modifications come to mind without significantly departing from the spirit of the invention and the scope of protection is limited by the scope of the accompanying claims.

What is claimed is:

1. A device for blocking the ringing of a doorbell, said device comprising:
a cover body having at least a front side,
said side having an interior and an exterior surface,
said front side having a selectively closable opening having an outer perimeter, and
said front side further having at least one hole therein for allowing passage of a securing device therethrough for securing said door bell blocking device to a desired object.

2. The device for blocking the ringing of a doorbell according to claim 1, wherein said selectively closable opening comprises:
a plurality of panels slidably attached to said interior side of said front surface and slidably movable between an open position and a closed position, and
said panels being operatively interconnected.

3. The device for blocking the ringing of a doorbell according to claim 2, wherein said panels stack, one in front of the other, substantially outside said outer perimeter of said selectively closeable opening, when said panels are in said open position.

4. The device for blocking the ringing of a doorbell according to claim 3, wherein the rearward most panel of said plurality of panels comprises a user graspable portion for selectively sliding said plurality of panels between said open and said closed positions.

5. The device for blocking the ringing of a doorbell according to claim 2, wherein said plurality of panels comprise written indicia viewable when said panels are in said closed position.

6. The device for blocking the ringing of a doorbell according to claim 1, wherein said at least one hole is positioned such that said securing device replaces a securing device of said doorbell to be blocked.

7. The device for blocking the ringing of a doorbell according to claim 1, wherein said at least one hole comprises two holes.

8. The device for blocking the ringing of a doorbell according to claim 7, wherein said two holes are positioned such that said securing device replaces a securing device of said doorbell to be blocked.

9. The device according to claim 2, where said exterior side comprises indentations positioned to enable a user's finger to engage said tab.

10. The device according to claim 2, wherein said panels include a plate to magnetically engage a magnet on the interior surface wherein said plate and magnet hold the device in a closed position.

11. The device according to claim 2, wherein said panels include a plate to magnetically engage a magnet on the interior surface wherein said plate and magnet hold the device in an open position.

12. The device according to claim 2, wherein said panels include a magnet to magnetically engage a plate on the interior surface wherein said plate and magnet hold the device in an open position.

13. The device according to claim 2, wherein said panels include a magnet to magnetically engage a plate on the interior surface wherein said plate and magnet hold the device in a closed position.
